(19) United States
(12) Patent Application Publication
(10) Pub. No.: US 2003/0098912 A1
(43) Pub. Date: May 29, 2003

(54) Solid-state image pickup apparatus and fabricating method thereof

(76) Inventors: Shigeru Hosokai, Tokyo (JP); Kenji Miyata, Okaya-shi (JP)

Correspondence Address: STRAUB & POKOTYLO, 1 BETHANY ROAD, SUITE 83, BUILDING 6, HAZLET, NJ, 07730, US

(21) Appl. No.: 10/300,517

(22) Filed: Nov. 20, 2002

(30) Foreign Application Priority Data
Nov. 29, 2001 (JP) 2001-363574

(51) Int. Cl. H04N 5/225

(52) U.S. Cl. 348/207.99

(57) ABSTRACT

A solid-state image pickup apparatus including a hermetic seal portion having a strong and reliable frame part capable of reducing mixture with bubbles and of being adjusted in height is formed such that an adhesive layer for forming the frame part to which a filler is added is adhered to a sealing region of edge portions on a solid-state image pickup device chip with excluding a light receiving portion thereof and a transparent member such as of glass is adhered onto the adhesive layer.

This application claims benefit of Japanese Application No. 2001-363574 filed in Japan on Nov. 29, 2001, the contents of which are incorporated by this reference.

### BACKGROUND OF THE INVENTION

The present invention relates to solid-state image pickup apparatus and fabricating method thereof having a solid-state image pickup device chip packaged in hermetic seal.

In recent years, there has been an advancement in size reduction of electronic apparatus mainly such as of portable equipment and, as a result, a further downsizing is demanded also of the casing and inner circuit boards therefor. Of those parts to be mounted on a circuit board, semiconductor devices are not excepted from such demands for downsized equipment and are required to be reduced in size. The same can be said of solid-state image pickup devices which are among the semiconductor devices.

A packaging system as typically represented by the construction shown in FIG. 1 has generally been used for solid-state image pickup devices. In particular, a solid-state image pickup device chip 101 is die-bonded to a package 102 for example of ceramics and a bonding wire 103 is used to achieve a predetermined electrical connections between the solid-state image pickup device chip 101 and package 102. The solid-state image pickup apparatus is then formed such that a glass lid 105 is adhered thereto by using a step portion 104 formed at edges of package 102 so as to achieve a hermetic seal with providing a space over the surface of the solid-state image pickup device chip 101.

It should be noted that numeral 106 in FIG. 1 denotes an external lead.

In solid-state image pickup apparatus having such construction, use of package 102 and glass lid 105 for hermetically sealing the entire solid-state image pickup device chip has been the cause of an increased packaging size and difficult to be applied to those fields where downsized packaging is required.

To eliminate such disadvantage, a solid-state image pickup apparatus of the construction as shown in FIG. 2 has previously been proposed by the present applicant in Japanese patent laid-open application 2001-257334 (U.S. patent application Ser. No. 09/800,516). In the proposed solid-state image pickup apparatus, an epoxy-type resin sheet 202 having a hole only at the portion corresponding to a light receiving area on solid-state image pickup device chip 201 is adhered by means of adhesive 203 to the solid state image pickup device chip 201 and to a flat plate member 204 for forming a hermetic seal. Here the epoxy-type resin sheet 202 serves as a frame portion of the hermetic seal portion.

By the solid-sate image pickup apparatus of such construction, a smaller size packaging thereof becomes possible. At the same time, especially in a solid-state image pickup apparatus having a micro-lens, the solid-state image pickup apparatus can be achieved without degrading the light converging capability of the micro-lens even when such optical components as a filter, lens, and prism, etc., are adhered to the surface of the hermetic seal portion. Further, fabrication method has also become simpler, since hermetic seal portions can be formed at once for all of solid-state image pickup device chips in a wafer.

The previously proposed solid-state image pickup apparatus as described above, however, also has problems as follows. First, bubbles might get mixed with the adhesive layer when the flat plate member and the epoxy-type resin sheet are bonded to each other by the adhesive. An excessive mixture of bubbles results in a formation of air pass to the external space. This is unfavorable from the viewpoint of reliability. Further, if the bubbles are to be excluded in the bonding, an exclusive equipment such as one used in forming a build-up board becomes necessary. This results in an increased cost.

Further, in order to form a cavity section of the hermetic seal portion by the epoxy-type resin sheet which becomes a frame part of the hermetic seal portion, handling of a previously die-cut epoxy-type resin sheet becomes necessary. The operability is unfavorable. Also, since the die cutting must be performed so as to leave the portion serving as frame part, it might be difficult to form a complicated pattern.

On the other hand, in the case where a film serving as the frame part is to be formed from an adhesive layer alone, since a material for determining height of the frame part is not contained, it is possible that the height of the frame part becomes uneven after the pressure bonding of the flat plate member for effecting hermetic seal. Further, lack of strength of the frame part is predicted and its reliability might be a problem.

### SUMMARY OF THE INVENTION

To eliminate the above problems, it is a main object of the present invention to provide a solid-state image pickup apparatus capable of downsizing while having a reliable hermetic seal portion by providing a frame part of which mixture with bubbles is suppressed and which can be adjusted in height with having a certain strength.

A fundamental construction of the solid-state image pickup apparatus according to the invention includes: a solid-state image pickup device chip; and a hermetic seal portion provided over the solid-state image pickup device chip as having a flat-plate member made of a transparent material and a frame part disposed on edge portions of a lower surface of the flat-plate member. The frame part of the hermetic seal portion is formed by an adhesive layer containing a filler disposed directly on the solid-state image pickup device chip.

By such construction, it is possible to form a frame part of which mixture with bubbles is suppressed and which can be adjusted in height with having a certain strength so that the solid-state image pickup apparatus is achieved as that which can be downsized and at the same time has a reliable hermetic seal portion. The above main object is thereby accomplished.

It is another object of the invention to provide a solid-state image pickup apparatus capable of readily and suitably forming a hermetic seal portion.

In a further aspect of the invention, of the solid-state image pickup apparatus of the above described fundamental construction, the frame part consisting of the adhesive layer is formed such that an adhesive containing a filler is applied to one or the other of a lower surface edge portion of the flat plate member and an edge portion of the solid-state image pickup device chip or such that adhesive layers containing a filler are formed as applied to both the surface of a lower surface edge portion of the flat plate member and the surface of an edge portion of the solid-state image pickup device chip and are bonded to each other.

By such construction, it is possible to more readily and suitably form a hermetic seal portion where mixture with bubbles can be suppressed and an adjustment in height is possible. The above object is thereby accomplished.

It is still another object of the invention to provide a solid-state image pickup apparatus in which a shielding effect against unwanted rays of light at solid-state image pickup device chip can be obtained without providing a separate member for shielding light.

In a further aspect of the invention, of the solid-state image pickup apparatus of the above fundamental construction, the adhesive layer containing a filler for forming the frame part has a function for shielding light by means of coloring or the like.

By such construction, a shielding effect against unwanted rays of light at solid-state image pickup device chip can be imparted to the sealing region of the hermetic seal portion. The above object is thereby accomplished.

It is yet another object of the invention to provide an optimal structure for electrical connection between the solid-state image pickup device chip and an external terminal in solid-state image pickup apparatus having a hermetic seal portion.

In a further aspect of the invention, of the solid-state image pickup apparatus of the above fundamental construction, a wiring region is formed as extended from an electrode pad provided on the solid-state image pickup device chip to a side surface of the solid-state image pickup device chip or from the electrode pad through a side surface to a back surface of the chip so that an external terminal can be electrically connected to the wiring region.

By such construction, it is possible to achieve and to apply to various packaging forms an optimal structure for electrical connection between the solid-state image pickup device chip having the hermetic seal portion in the above described construction and an external terminal. The above object is thereby accomplished.

It is another object of the invention to provide a fabricating method of solid-state image pickup apparatus capable of readily forming a hermetic seal portion accurately registered with respect to solid-state image pickup device chip.

In a further aspect of the invention, a fabricating method of solid-state image pickup apparatus having a solid-state image pickup device chip and a hermetic seal portion provided over the solid-state image pickup device chip as having a flat-plate member made of a transparent material and a frame part disposed on edge portions of a lower surface of the flat-plate member includes the steps of: over an entire wafer having a large number of solid-state image pickup device chips formed thereon, integrally and correspondingly to each individual solid-state image pickup device chip, forming a hermetic seal portion constituted by a flat-plate member made of a transparent material and a frame part made of an adhesive layer containing a filler disposed on lower surface edges of the flat-plate member; and separating the wafer having the integrally formed hermetic seal portions thereon into solid-state image pickup device chips each having an individual hermetic seal portion.

By using such fabricating steps, the hermetic seal portions can be formed at once on respective solid-state image pickup device chips in the form of a wafer. Accordingly, it becomes possible to readily fabricate a solid-state image pickup apparatus having a hermetic seal portion registered accurately on solid-state image pickup device chip. The above object is thereby accomplished.

### BRIEF DESCRIPTION OF THE DRAWINGS

FIG. 1 is a sectional view showing a typical construction of solid-state image pickup apparatus packaged in a conventional hermetic seal.

FIG. 2 is a sectional view showing the construction of the solid-state image pickup apparatus having a hermetic seal portion previously proposed by the present applicant.

FIG. 3 is a top view showing an embodiment of the solid-state image pickup apparatus according to the invention in a manner removing the flat plate member therefrom.

FIG. 4 shows a section of the embodiment shown in FIG. 3.

FIG. 5 is a perspective view showing the relation between mask and transparent member in fabrication process, for explaining an embodiment of the fabricating method of solid-state image pickup apparatus according to the invention.

FIG. 6 is a sectional view showing a manner of combining the mask and transparent member in the fabrication process shown in FIG. 5.

FIG. 7 shows fabricating process continued from the fabricating process shown in FIGS. 5 and 6.

FIG. 8 shows fabricating process continued from the fabricating process shown in FIG. 7.

FIG. 9 shows fabricating process continued from the fabricating process shown in FIG. 8.

FIG. 10 shows an example of the manner of packaging of solid-state image pickup apparatus according to an embodiment of the invention.

FIG. 11 shows a manner of bringing out electrodes from a pad portion of the solid-state image pickup apparatus according to an embodiment of the invention.

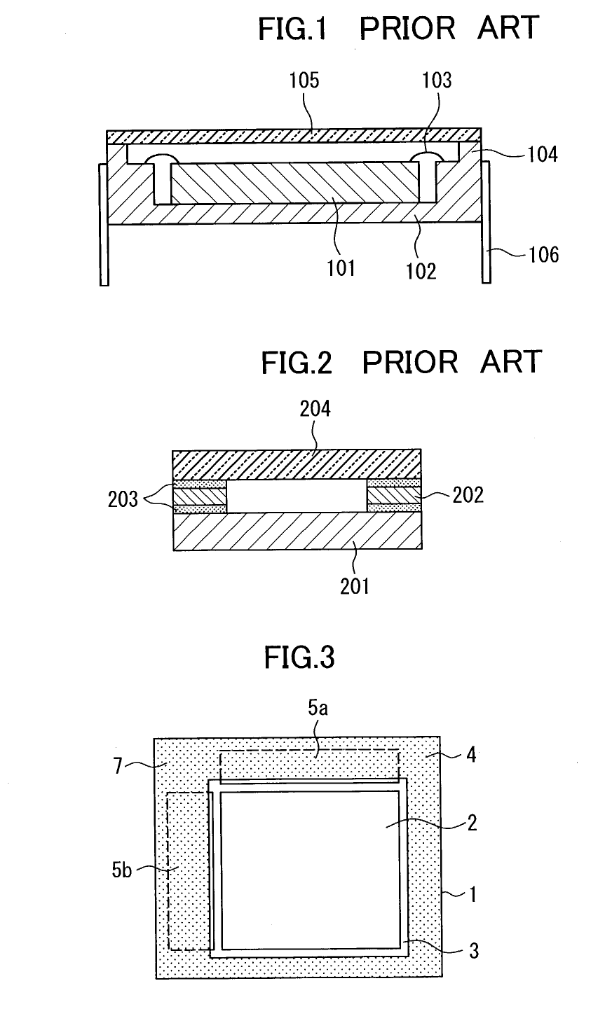

### DESCRIPTION OF THE PREFERRED EMBODIMENTS

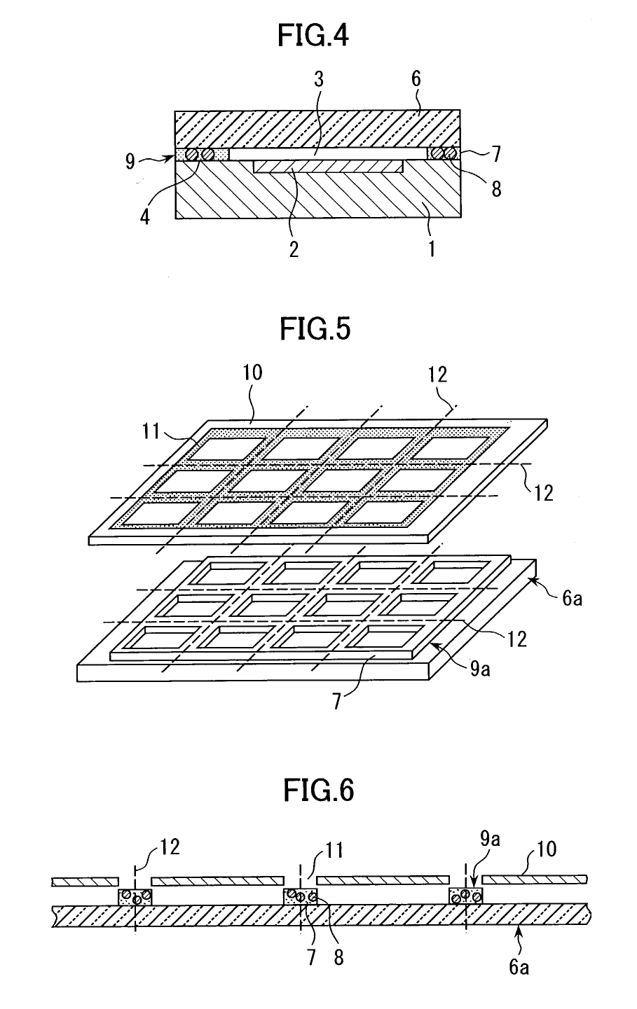

A description will now be given with respect to some embodiments of the solid-state image pickup apparatus according to the invention and fabricating method thereof. First, an embodiment of the solid-state image pickup apparatus according to the invention will be described below. FIGS. 3 and 4 are a top view and sectional view, respectively, showing an embodiment of the solid-state image pickup apparatus according to the invention in with omitting a part thereof. Referring to the figures, numeral 1 denotes a solid-state image pickup device chip to which an adhesive layer containing filler 8 as an additive is adhered at a sealing region 4 except a light receiving portion 2. A transparent member 6 such as of glass is adhered onto the adhesive layer 7 so as to form the solid-state image pickup apparatus. Accordingly, this construction is with a hermetic seal portion where the adhesive layer 7 containing filler 8 as additive serves as a frame part 9 and the transparent member 6 serves as a flat plate member. It should be noted that, in FIG. 3, numeral 3 denotes a hermetically sealed portion and numerals 5a, 5b denote peripheral circuits such as a scanning circuit of the light receiving portion 2 of the solid-state image pickup apparatus 1. Here, the height of the frame part 9 is determined by the size, i.e., grain size of filler 8. Further, the frame width of the frame part 9 can be of any size to the extent that it possesses a strength for retaining the transparent member 6 which becomes the flat plate member and it does not affect the characteristics of the solid-state image pickup device chip 1.

Of the adhesive containing a filler for forming the adhesive layer 7 serving as the frame part 9, it is important to adjust thixotropy by adding, in addition to the filler 8, a thixotropic agent to the extent not affecting the characteristics so that viscosity when stirred before forming the frame part and at the time of forming of the frame part is lowered and the viscosity when placed in a stationary condition is increased to a degree capable of retaining the shape of the frame part. In short, an adhesive having high thixotropy is preferable.

Such adhesives includes but not limited to epoxy- or silicone-type adhesives and any material can be used as far as it possesses the above characteristics and provides a sufficient bonding strength between the solid-state image pickup device chip 1 and the transparent member 6 serving as the flat plate member and, in addition, is capable of avoiding to the extent possible penetration at the time of bonding into the hermetically sealed portion 3 such as of the light receiving portion 2 in the bonding process to be described later.

On the other hand, it is essential for the filler 8 to be chemically stable against the adhesive to which the filler is to be added, to have an insulating property and at the same time to have a certain strength so as not to be destroyed at the time of pressure bonding between the solid-state image pickup device chip 1 and the transparent member 6. While silica for example is among those which are suitable as the filler 8, any material satisfying the above conditions can be used. The diameter of the filler 8 of about 50 μm is preferably required. The filler diameter however is suitably selected so that a frame height is obtained with providing a margin for the size of a three-dimensional structure such as micro-lens that is formed on the solid-state image pickup device chip 1. Further, quartz or sapphire as well as glass is preferably used as the material of the transparent member 6 which becomes the flat plate member.

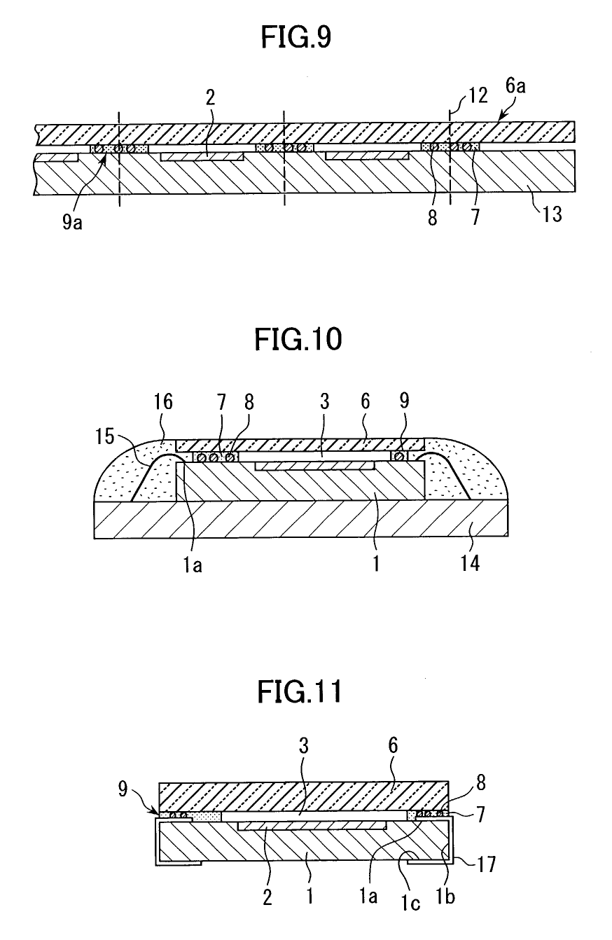

A description will now be given by way of FIGS. 5 to 9, with respect to an example of the fabricating method of the solid-state image pickup apparatus according to the invention. First as shown in FIGS. 5 and 6, a frame part 9a of the hermetic seal portion consisting of adhesive layer 7 to which filler and thixotropic agent are added is integrally formed on a transparent member 6a for example made of glass of the size corresponding to a wafer having a large number of solid-state image pickup device chips formed thereon in a manner corresponding to each of the individual solid-state image pickup device chips. In forming of the frame part 9a, the adhesive layer 7 is pattern-printed by using a mask 10 having a mesh region 11 where as shown in FIG. 6 holes are formed so as to be well capable of allowing the passage of filler 8 to be added to the adhesive layer 7. The viscosity thereof is increased by placing it in a stationary condition for a period of time so as to prevent sagging. Alternatively, it can also be temporarily cured by means of heating. It should be noted that the amount of thixotropic agent to be added to the adhesive layer 7 is adjusted so as to achieve a readily usable viscosity by considering the size of the mask mesh, the filler to be added, and the width/shape of the frame part.

Here, the shape and area of the frame part 9a, i.e., the sealing region can be an optional shape and area as far as the light receiving portion 2 of the solid-state image pickup apparatus 1 is excluded when the hermetic seal portion is complete and the light receiving portion 2 is not adversely affected. Further, the sealing region can be set at will according to the packaging construction as will be described later. Referring to FIGS. 5 and 6, numeral 12 denotes scribed lines for dicing to be described later.

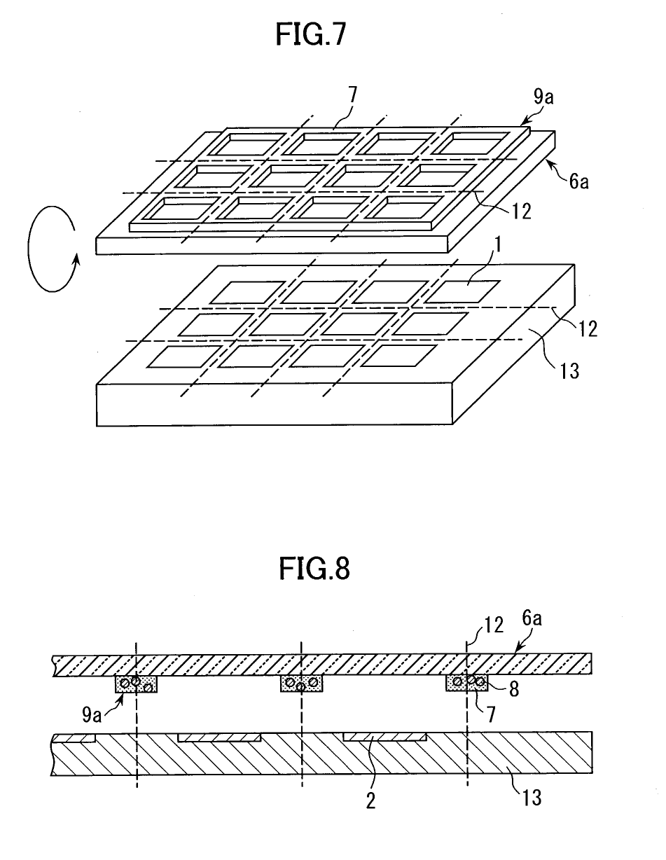

Next, as shown in FIGS. 7 to 9, the transparent member 6a having the frame part 9a formed thereon is placed as inverted on a wafer 13 having a large number of solid-state image pickup device chips 1 formed thereon and these are aligned to be pressure-bonded. At this time, the height of frame part 9a is uniformly determined by the diameter of the filler 8. It is important here to previously set the amount of the adhesive with considering its spread so as not to adversely affect the light receiving portion 2 of the solid-state image pickup device chip 1 as a result that the adhesive layer 7 of the frame part 9a overflows at the time of pressure bonding.

It is also possible that a micro-lens or color filter for example is formed for example on-chip or by means of laminating on the solid-state image pickup device chip 1. Further, when the transparent member 6a becoming the flat plate member is bonded to the wafer 13, it is possible to use the alignment mark on the wafer 13 at the manufacture of the solid-state image pickup device chip 1. Since an accurate registration thus becomes possible, the hermetic seal portion can be formed with precision. By then dicing the wafer 13 and transparent member 6a along the scribed lines 12, a solid-state image pickup apparatus is obtained as shown in FIG. 4 as having the hermetic seal portion formed by the flat plate member consisting of transparent member 6 and the frame part 9.

By such construction and fabricating method, spew of adhesive to the hermetically sealed potion 3 such as the light receiving portion 2 is eliminated and the mixture of bubbles into the frame part 9 can be reduced. Further, height of the frame part 9 can be adjusted and the height is uniform. The strength thereof is also adequate. It is thereby possible to form a reliable hermetic seal portion and to prevent adverse effects on the image pickup characteristics.

The fabricating method shown in this example has been, but naturally not limited to one in which the frame part 9a is formed on the transparent member 6a becoming the flat plate member and is pressure-bonded to the wafer 13. It is also possible that the frame part 9a is formed on the wafer 13 and then pressure-bonded to the transparent member 6a or that parts of the frame portion 9a are formed respectively on the transparent member 6a and on the wafer 13 and the transparent member 6a and the wafer 13 are bonded to each other.

Further, by using a colored adhesive or filler or both as colored for example in black so as to cut off light, the frame part of the hermetic seal portion serves as a light shielding section so that unwanted rays of light onto the solid-state image pickup device chip can be cut off. Accordingly, adverse effects due to stray light or reflection on the solid-state image pickup device chip can be prevented.

A description will now be given with respect to the packaging and the manner of bringing out electrodes from a pad portion of the solid-state image pickup apparatus having the above described construction. FIG. 10 shows an example of packaging where the solid-state image pickup device chip 1 is packaged as it is die-bonded to package or substrate 14 and a bonding wire 15 is used to effect a specified connection between a pad portion 1a of the solid-state image pickup device chip 1 and the package or substrate 14. Though this configuration itself is adequate, it is also possible that a peripheral portion including the bonding wire connecting section except the hermetic seal portion is resin-sealed as shown in the figure by a sealing resin 16. In this construction, however, it is necessary that the frame part 9 of the hermetic seal portion consisting of adhesive layer 7 to which filler is added is formed with excluding the pad portion 1a of the solid-state image pickup device chip 1.

FIG. 11 shows an example of the manner of bringing out electrodes from the pad portion. A wiring region 17 is formed from the pad portion 1a on the solid-state image pickup device chip 1 to a chip side surface 1b or to a back surface 1c through the chip side surface 1b. It is furthermore possible that an additional electrode pad is provided in the wiring region on the back surface so as to be connected to a substrate or the like by using a bump, etc. In the case of forming such wiring region 17, it suffices to form the frame part 9 over the pad portion 1a so that the light receiving portion 2 or the chip 1 as a whole is hermetically sealed. Further it is also possible that an external lead (not shown) for example is connected to the wiring region 17 of the chip side surface 1b so as to achieve an electrical connection with an external terminal.

By using the construction as shown in FIG. 11, packaging becomes unnecessary so that the solid-state image pickup device chip can be mounted directly on various boards such as a circuit board having for example a signal processing circuit formed thereon. Further, laminating and bonding with other semiconductor chip having for example a signal generation circuit and signal processing circuit formed thereon can be readily effected by the wiring region or electrode pad provided on the back surface of the solid-state image pickup device chip. Accordingly, it becomes possible to readily fabricate even a solid-state image pickup apparatus of laminate structure where a solid-state image pickup device and signal processing circuit for example are integrally formed so that the solid-state image pickup apparatus including its peripheral circuits can be further reduced in size.

It should be noted that the packaging configuration shown in FIG. 10 and the manner of bringing out electrodes from the pad portion as shown in FIG. 11 have been shown by way of examples only, and various other configurations are naturally also possible.

Further, while the present invention is related to solid-state image pickup apparatus packaged as having a hermetically sealed solid-state image pickup device chip, such hermetically sealed packaging technique of solid-state image pickup device chip is well applicable to and capable of expecting a similar advantage on the hermetically sealed packaging of other semiconductor chips.

As has been described by way of the above embodiments, it is possible according to the invention to achieve a solid-state image pickup apparatus having a highly reliable hermetic seal portion, which can be reduced in size, is capable of preventing degradation of image pickup characteristics by controlling an overflow of adhesive layer to a minimum and of accurately regulating the height of the hermetic seal portion and in which mixing of bubbles at the time of forming the frame part can be reduced. Further, according to the invention, a solid-state image pickup apparatus having a hermetic seal portion can be provided as capable of preventing adverse effects for example due to stray light or reflection on the solid-state image pickup device chip, without providing a separate light shielding member. Further, according to the invention, a solid-state image pickup apparatus having a hermetic seal portion can be provided as capable of obtaining an optimal structure for electrical connection between the solid-state image pickup device chip and an external terminal so that it can correspond to various packaging form. Further, with the fabricating method of solid-state image pickup apparatus according to the invention, a solid-state image pickup apparatus having a hermetic seal portion accurately registered on the solid-state image pickup device chip can be readily fabricated, since hermetic seal portions are formed at once on the respective solid-state image pickup device chips in the form of a wafer.

What is claimed is:

1. A solid-state image pickup apparatus comprising:
a solid-state image pickup device chip; and
a hermetic seal portion provided over the solid-state image pickup device chip as having a flat-plate member made of a transparent material and a frame part disposed on edge portions of a lower surface of the flat-plate member;
wherein said frame part of said hermetic seal portion comprises an adhesive layer containing a filler disposed directly on said solid-state image pickup device chip.

2. The solid-state image pickup apparatus according to claim 1, wherein the frame part consisting of said adhesive layer is formed by applying an adhesive containing a filler to one or the other of a lower surface edge portion of said flat plate member and an edge portion of the solid-state image pickup device chip or is formed by bonding to each other adhesive layers containing a filler formed as applied to both the surface of a lower surface edge portion of said flat plate member and the surface of an edge portion of the solid-state image pickup device chip.

3. The solid-state image pickup apparatus according to claim 1, wherein the adhesive layer containing a filler for forming said frame part has a function for shielding light by means of coloring or the like.

4. The solid-state image pickup apparatus according to claim 2, wherein the adhesive layer containing a filler for forming said frame part has a function for shielding light by means of coloring or the like.

5. The solid-state image pickup apparatus according to claim 1, wherein a wiring region is formed as extended from an electrode pad provided on the solid-state image pickup device chip to a side surface of said solid-state image pickup device chip or from the electrode pad through a side surface to a back surface of the chip so that an external terminal can be electrically connected to the wiring region.

6. The solid-state image pickup apparatus according to claim 2, wherein a wiring region is formed as extended from an electrode pad provided on the solid-state image pickup device chip to a side surface of said solid-state image pickup device chip or from the electrode pad through a side surface to a back surface of the chip so that an external terminal can be electrically connected to the wiring region.

7. The solid-state image pickup apparatus according to claim 3, wherein a wiring region is formed as extended from an electrode pad provided on the solid-state image pickup device chip to a side surface of said solid-state image pickup device chip or from the electrode pad through a side surface to a back surface of the chip so that an external terminal can be electrically connected to the wiring region.

8. The solid-state image pickup apparatus according to claim 4, wherein a wiring region is formed as extended from an electrode pad provided on the solid-state image pickup device chip to a side surface of said solid-state image pickup device chip or from the electrode pad through a side surface to a back surface of the chip so that an external terminal can be electrically connected to the wiring region.

9. A fabricating method of solid-state image pickup apparatus including a solid-state image pickup device chip and a hermetic seal portion provided over the solid-state image pickup device chip having a flat-plate member made of a transparent material and a frame part disposed on edge portions of a lower surface of the flat-plate member, said fabricating method of solid-state image pickup apparatus comprising the steps of:
over an entire wafer having a large number of solid-state image pickup device chips formed thereon, integrally and correspondingly to each individual solid-state image pickup device chip, forming a hermetic seal portion constituted by a flat-plate member made of a transparent material and a frame part made of an adhesive layer containing a filler disposed on lower surface edges of the flat-plate member; and
separating the wafer having the integrally formed hermetic seal portions thereon into solid-state image pickup device chips each having an individual hermetic seal portion.
